(19) United States
(12) Patent Application Publication
(10) Pub. No.: US 2010/0027407 A1
(43) Pub. Date: Feb. 4, 2010

(54) TRANSCEIVER AND ECHO CANCELLATION METHOD

(75) Inventor: Tsu-Chun Liu, Hsin-Chu (TW)

Correspondence Address: J C PATENTS, 4 VENTURE, SUITE 250, IRVINE, CA, 92618, US

(73) Assignee: IC PLUS CORP., Hsin-Chu (TW)

(21) Appl. No.: 12/243,194

(22) Filed: Oct. 1, 2008

(30) Foreign Application Priority Data
Jul. 30, 2008 (TW) 97128857

(51) Int. Cl. H04J 3/10

(52) U.S. Cl. 370/201

(57) ABSTRACT

A transceiver and an echo cancellation method are disclosed. The echo cancellation method includes producing an echo cancellation signal according to a transmission signal; adjusting the amplitude, the delay time or a combination of the amplitude and the delay time of the echo cancellation signal according to an adjusting parameter; receiving an echo signal derived from the transmission signal and performing a subtraction operation on the echo signal by using the echo cancellation signal so as to obtain an echo residual; and producing the adjusting parameter according to the echo residual. The provided method can effectively reduce the interference caused by the echo signal.

### CROSS-REFERENCE TO RELATED APPLICATION

This application claims the priority benefit of Taiwan application serial no. 97128857, filed on Jul. 30, 2008. The entirety of the above-mentioned patent application is hereby incorporated by reference herein and made a part of specification.

### BACKGROUND OF THE INVENTION

1. Field of the Invention

The present invention generally relates to an echo cancellation technique, and more particularly, to an echo cancellation technique by using a feedback scheme to adjust the parameter of a hybrid module.

2. Description of Related Art

FIG. 1 is a diagram of a conventional full-duplex digital transceiver. Referring to FIG. 1, both ends of a transmission line 22 are respectively connected to a transceiver 18 and a transceiver 20. For example, the left transceiver 18 includes a transmitter 12, a receiver 14 and a hybrid module 16.

Both transmitter 12 and receiver 14 are connected to the hybrid module 16 so as to simultaneously receive signals and transmit signals. Assuming the left full-duplex digital transceiver 18 is the near-end, and the right full-duplex digital transceiver 20 is the far-end; when the transmitter 12 transmits a signal reaching the full-duplex digital transceiver 20, it often produces a near-end echo signal and a far-end echo signal due to a mismatching impedance between the transmission line 22 and the full-duplex digital transceiver 18 or other sources. When the near-end echo signal and the far-end echo signal reach the near-end full-duplex digital transceiver 18, the signal received by the receiver 14 is disturbed with an interference noise.

### SUMMARY OF THE INVENTION

Accordingly, the present invention is directed to a transceiver capable of cancelling an echo signal.

The present invention is also directed to an echo cancellation method for reducing the interference caused by an echo signal.

The present invention provides a transceiver, which includes a transmitter, a hybrid module, an echo cancellation unit and a control module. The transmitter outputs a transmission signal. The hybrid module is coupled to the transmitter for producing an echo cancellation signal according to the transmission signal and adjusting the amplitude, the delay time or a combination of the amplitude and the delay time of the echo cancellation signal according to an adjusting parameter. The echo cancellation unit is coupled to the transmitter and the hybrid module for receiving an echo signal derived from the transmission signal and performing a subtraction operation on the echo signal by using the echo cancellation signal to obtain an echo residual. The control module is coupled to the echo cancellation unit and the hybrid module for producing the adjusting parameter according to the echo residual.

In an embodiment of the present invention, the hybrid module includes an amplitude adjustment unit. The amplitude adjustment unit is coupled to the transmitter and the echo cancellation unit for adjusting the amplitude of the echo cancellation signal according to the adjusting parameter. In another embodiment, the hybrid module includes a delay unit. The delay unit is coupled to the transmitter, the amplitude adjustment unit and the echo cancellation unit for adjusting the delay time of the echo cancellation signal according to the adjusting parameter.

In an embodiment of the present invention, the transceiver further includes a low-pass filter. The low-pass filter is coupled to the echo cancellation unit for low-pass filtering on the echo residual. In another embodiment, the transceiver further includes an analog-to-digital converter (ADC). The ADC is coupled to the echo cancellation unit and the control module for converting the echo residual into a digital signal and outputting the digital signal to the control module. In yet another embodiment, the echo cancellation unit is a subtractor.

In addition, the present invention provides an echo cancellation method. The method includes: outputting a transmission signal and producing an echo cancellation signal according to the transmission signal; adjusting the amplitude, the delay time or a combination of the amplitude and the delay time of the echo cancellation signal according to an adjusting parameter; receiving an echo signal derived from the transmission signal and performing a subtraction operation on the echo signal by using the echo cancellation signal so as to obtain an echo residual; and producing the adjusting parameter according to the echo residual.

The present invention is able to produce an echo cancellation signal according to the transmission signal and adjust the amplitude, the delay time or a combination of the amplitude and the delay time of the echo cancellation signal according to the adjusting parameter. The present invention is also able to receive the echo signal derived from the transmission signal, and perform a subtraction operation on the echo signal by using the echo cancellation signal so as to obtain the echo residual. The present invention is further able to produce the adjusting parameter according to the echo residual. Therefore, the interference of the echo signal may be effectively reduced.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of a conventional full-duplex digital transceiver.

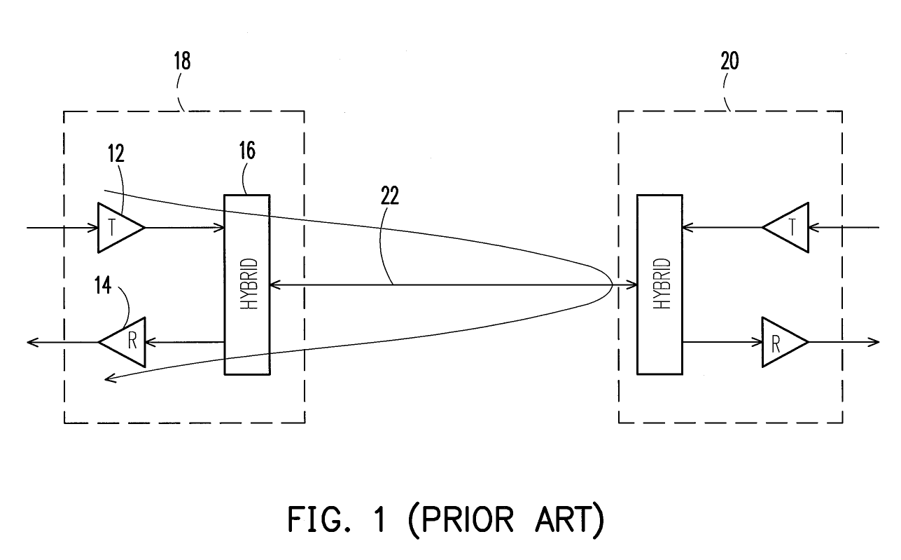

FIG. 2 is a block diagram of a transceiver according to an embodiment of the present invention.

FIG. 3 is a block diagram of a transceiver according to another embodiment of the present invention.

FIG. 4 is a flowchart of an echo cancellation method according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In the prior art, it is well known that an echo signal can not be effectively eliminated. Accordingly, an embodiment of the present invention provides an echo cancellation technique of a transceiver. The echo signal is varied with the application environment of the transceiver. Therefore, the transceiver in the embodiments of the present invention is able to automatically adjust the parameter of a hybrid module according to the received echo signal so as to effectively cancel the echo signal. The following depiction is accompanied with several figures.

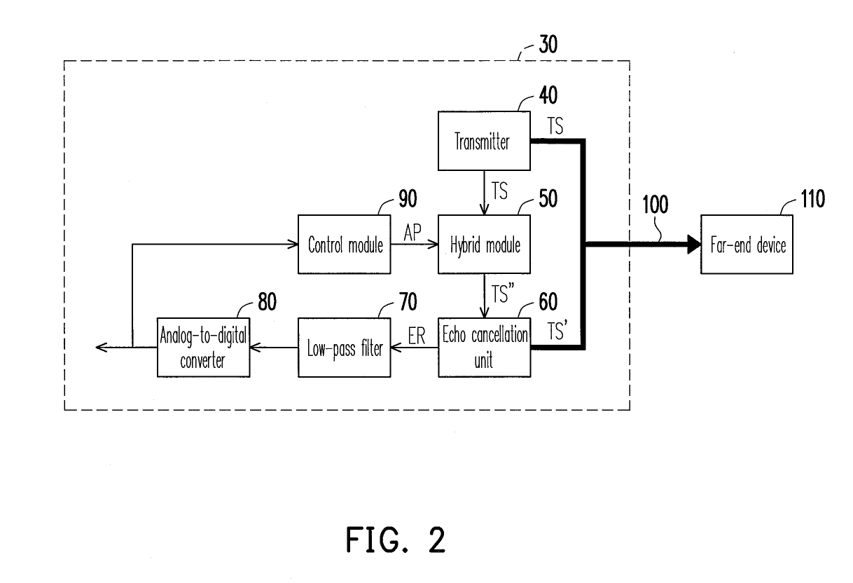

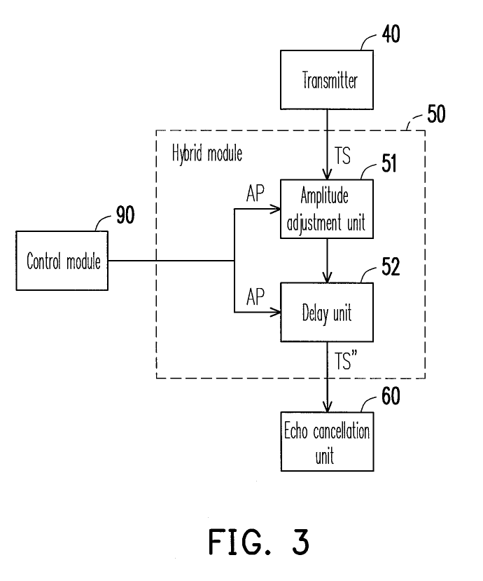

FIG. 2 is a block diagram of a transceiver according to an embodiment of the present invention. FIG. 3 is a block diagram of a transceiver according to another embodiment of the present invention. Referring to FIGS. 2 and 3, in the embodiments, a transceiver 30 includes a transmitter 40, a hybrid module 50, an echo cancellation unit 60, a low-pass filter 70, an ADC 80 and a control module 90. The hybrid module 50 includes, for example, an amplitude adjustment unit 51 and a delay unit 52, wherein the amplitude adjustment unit 51 is coupled to the transmitter 40, the delay unit 52 and the control module 90. The delay unit 52 is coupled to the control module 90 and the echo cancellation unit 60. The low-pass filter 70 is coupled to the echo cancellation unit 60. The ADC 80 is coupled to the low-pass filter 70 and the control module 90.

In the embodiment, the transceiver 30 is able to communicate with a far-end device 110 in a full-duplex mode through the transmission line 100. Although the embodiment take a cable transmission application as an example, but the present invention is not limited to the cable transmission. In other embodiments, the transceiver 30 can communicate with the far-end device 110 in a wireless mode. In addition, the above-mentioned far-end device 110 can be, for example, a far-end transceiver, which the present invention is not limited thereto. Moreover, in yet other embodiments, the far-end device 110 can be other devices producing an echo signal.

The transmitter 40 outputs a transmission signal TS to the far-end device 110 through the transmission line 100, and the transceiver 30 is able to receive the signal sent from the far-end device 110 through the transmission line 100 as well. The transceiver 30 herein communicates with the far-end device 110 in the full-duplex mode. In other words, the transceiver 30 can send the transmission signal TS to the far-end device 110 and receive an echo signal TS′ derived from the transmission signal TS. For the transceiver 30, the echo signal TS′ is a noise; therefore, if the echo signal TS′ can be cancelled, the signal to noise ratio (SNR) of the transceiver 30 would be increased. To accomplish the above-mentioned goal, the embodiments utilizes the hybrid module 50, the echo cancellation unit 60, the low-pass filter 70, the ADC 80 and the control module 90 for reducing the interference of the echo signal TS′.

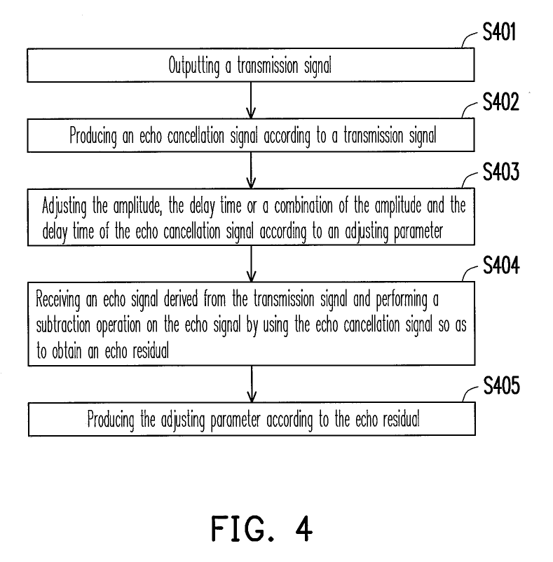

FIG. 4 is a flowchart of an echo cancellation method according to an embodiment of the present invention. Referring to FIGS. 2, 3 and 4, first in step S401, the transmitter 40 sends the transmission signal TS to the far-end device 110 and the hybrid module 50 through the transmission line 100, where the transmission signal TS can be, for example, a pulse signal.

Next in step S402, the hybrid module 50 produces an echo cancellation signal TS″ according to the transmission signal TS. Then, in step S403, the hybrid module 50 adjusts the amplitude, the delay time or a combination of the amplitude and the delay time of the echo cancellation signal TS″ according to an adjusting parameter AP. In more detail, the amplitude adjustment unit 51 adjusts the amplitude of the echo cancellation signal TS″ according to the preset adjusting parameter AP. In addition, the delay unit 52 adjusts the delay time of the echo cancellation signal TS″ according to the preset adjusting parameter AP. In other words, the amplitude adjustment unit 51 and the delay unit 52 of the hybrid module 50 are associated with each other to adjust the amplitude, the delay time or a combination of the amplitude and the delay time of the echo cancellation signal TS″, so that the echo cancellation signal TS″ is modified to be approximated to the echo signal TS′.

After that in step S404, the echo cancellation unit 60 receives the echo signal TS′ derived from the transmission signal TS and performs a subtraction operation on the echo signal TS′ by using the echo cancellation signal TS″ so as to produce an echo residual ER. In the embodiment, the echo cancellation unit 60 can be, for example, a subtractor.

Further in step S405, an adjusting parameter AP is produced according to the echo residual ER. In more detail, the echo cancellation unit 60 transmits the echo residual ER to the control module 90 through the low-pass filter 70 and the ADC 80, wherein the low-pass filter 70 is in charge of eliminating the high-frequency noise and the ADC 80 is in charge of converting an analog signal to a digital signal. The control module 90 produces a more suitable adjusting parameter AP according to the processed echo residual ER and outputs the adjusting parameter AP to the hybrid module 50.

For example, when the amplitude adjustment unit 51 adjusts the amplitude of the echo cancellation signal TS″ to be larger and an increased echo residual ER is yielded, the control module 90 would control the amplitude adjustment unit 51 through the adjusting parameter AP to reduce the amplitude of the echo cancellation signal TS″, so that the intensity of the echo residual ER kept within a preset range, for example, 0±Δt. In other embodiments, those skilled in the art can specify the above-mentioned preset range according to a specific application. On the other hand, when the amplitude adjustment unit 51 adjusts the amplitude of the echo cancellation signal TS″ to be smaller and an increased echo residual ER is yielded, the control module 90 would control the amplitude adjustment unit 51 through the adjusting parameter AP to increase the amplitude of the echo cancellation signal TS″, so as to weaken the echo residual ER.

Similarly, when the delay unit 52 increases the delay time of the echo cancellation signal TS″ and an increased echo residual ER is yielded, the control module 90 would control the delay unit 52 through the adjusting parameter AP to reduce the delay time of the echo cancellation signal TS″, so that the intensity of the echo residual ER kept within a preset range; when the delay unit 52 reduces the delay time of the echo cancellation signal TS″ and an increased echo residual ER is yielded, the control module 90 would control the delay unit 52 through the adjusting parameter AP to increase the delay time of the echo cancellation signal TS″, so as to weaken the echo residual ER.

In this way, the hybrid module 50 is able to adaptively adjust the amplitude, the delay time or a combination of the echo cancellation signal TS″ by using the more reasonable adjusting parameter AP, wherein the controlled echo cancellation signal TS″ more truly imitates the echo signal TS′ so that the echo cancellation unit 60 can effectively eliminate the echo signal TS′. Meanwhile, the present embodiment is able to promote the SNR of the transceiver 30 with a higher receiving accuracy.

The occurring time point or the intensity of the echo signal TS′ is varied with the application environment of the transceiver 30, for example, the type or length of the transmission line 100 would effect the echo signal TS′. Once the time point of outputting the echo cancellation signal TS″ by the hybrid module 50 or the intensity thereof is unable to automatically suit the echo signal TS′, the echo signal TS′ would not be effectively eliminated, even may enhance the echo residual ER. The present embodiment adopts the feedback scheme for automatically adjusting the parameter of the hybrid module 50. For example, the transceiver 30 can automatically correct the parameter of the hybrid module 50 in an auto negotiation phase, so that the hybrid module 50 is able to properly adjust the amplitude, the delay time or a combination of the amplitude and the delay time of the echo cancellation signal TS″ and make the echo cancellation signal TS″ approximated to the echo signal TS′.

Note that although the above-mentioned embodiments describes a feasible scheme for the transceiver 30 and the echo cancellation method, but anyone skilled in the art understands each manufacturer has unique design of the transceiver and the echo cancellation method. Based on the situation, the present invention is not limited to the above described scheme, wherein as long as the feedback technique is used to feed back the echo residual to the hybrid module for adjusting the parameter of the hybrid module, the scheme is construed to be within the scope of the present invention. Some more embodiments are described in the following for those skilled in the art to better understand the spirit of the present invention.

Continuing to FIG. 2, in the above-mentioned embodiments, although the echo residual ER is processed by the low-pass filter 70, the ADC 80 and the control module 90 for generating the adjusting parameter AP, but the present invention is not limited thereto. In other embodiments, the hybrid module 50 even directly receives the echo residual ER and sets the parameter according to the received echo residual ER, which has the efficiency similar to the above-mentioned embodiments.

Continuing to FIGS. 2 and 3, although in the above-mentioned embodiments, the hybrid module 50 includes the amplitude adjustment unit 51 and the delay unit 52; but in other embodiments, the hybrid module 50 includes only one of the amplitude adjustment unit 51 and the delay unit 52. In other words, anyone skilled in the art can adjust the amplitude or the delay time or a combination of the amplitude and the delay time of the echo cancellation signal according to the teachings of the present invention based on the practical need so as to make the echo cancellation signal TS″ approximated to the echo signal TS′.

Note that the implementation to produce the adjusting parameter AP in the above-mentioned embodiment is merely an example, and the present invention does not limit the implementation. In fact, in other embodiments, instead, a trial-and-error approach can be used for the control module. 90 to produce an adaptive adjusting parameter AP. In more detail, first, the control module 90 uses various adjusting parameters AP to obtain the corresponding echo residuals ER. Next, the control module 90 screens the obtained echo residuals ER to get a minimal echo residual ER. Obviously, the adjusting parameter AP corresponding to the minimal echo residual ER is the one more effectively to weaken the interference.

In summary, in the present invention, an echo cancellation signal is produced according to the transmission signal and the amplitude, the delay time or a combination of the amplitude and the delay time of the echo cancellation signal is adjusted according to an adjusting parameter. In addition, the echo signal derived from the transmission signal is received and a subtraction operation is performed on the echo signal by using the echo cancellation signal so as to produce an echo residual. Further, the adjusting parameter is generated according to the echo residual. In this way, the transceiver can automatically set the parameter of the hybrid module depending on different application environments, so that the echo cancellation signal is approximated to the echo signal to effectively reduce the interference of the echo signal.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A transceiver, comprising:
a transmitter for outputting a transmission signal;
a hybrid module, coupled to the transmitter for producing an echo cancellation signal according to the transmission signal and adjusting an amplitude, a delay time or a combination of the amplitude and the delay time of the echo cancellation signal according to an adjusting parameter;
an echo cancellation unit, coupled to the transmitter and the hybrid module for receiving an echo signal derived from the transmission signal and performing a subtraction operation on the echo signal by using the echo cancellation signal to obtain an echo residual; and
a control module, coupled to the echo cancellation unit and the hybrid module for producing the adjusting parameter according to the echo residual.

2. The transceiver according to claim 1, wherein the hybrid module comprises:
an amplitude adjustment unit, coupled to the transmitter and the echo cancellation unit for adjusting the amplitude of the echo cancellation signal according to the adjusting parameter.

3. The transceiver according to claim 2, wherein the hybrid module comprises:
a delay unit, coupled to the transmitter, the amplitude adjustment unit and the echo cancellation unit for adjusting the delay time of the echo cancellation signal according to the adjusting parameter so as to produce the echo cancellation signal in association with the amplitude adjustment unit.

4. The transceiver according to claim 1, wherein the hybrid module comprises:
a delay unit, coupled to the transmitter and the echo cancellation unit for adjusting the delay time of the echo cancellation signal according to the adjusting parameter so as to produce the echo cancellation signal.

5. The transceiver according to claim 1, further comprising:
a low-pass filter, coupled to the echo cancellation unit for low-pass filtering on the echo residual.

6. The transceiver according to claim 1, further comprising:
an analog-to-digital converter, coupled to the echo cancellation unit and the control module for converting the echo residual into a digital signal and outputting the digital signal to the control module.

7. The transceiver according to claim 1, wherein the echo cancellation unit is a subtractor.

8. An echo cancellation method, comprising:
outputting a transmission signal;
producing an echo cancellation signal according to the transmission signal;
adjusting an amplitude, a delay time or a combination of the amplitude and the delay time of the echo cancellation signal according to an adjusting parameter;
receiving an echo signal derived from the transmission signal and performing a subtraction operation on the echo signal by using the echo cancellation signal so as to obtain an echo residual; and
producing the adjusting parameter according to the echo residual.
